(19) United States
(12) Patent Application Publication
(10) Pub. No.: US 2026/0018333 A1
(43) Pub. Date: Jan. 15, 2026

(54) Multichannel EMI Inductors

(71) Applicant: Steward (Foshan) Magnetics Co., Ltd., Shunde District (CN)

(72) Inventors: Zengzhuo DENG, Lechang City (CN); Yongxue HE, Dublin, CA (US); Wenshan PANG, Foshan City (CN); Jacken ZHANG, Foshan City (CN)

(21) Appl. No.: 19/338,712

(22) Filed: Sep. 24, 2025

Related U.S. Application Data
(63) Continuation-in-part of application No. PCT/CN2023/097785, filed on Jun. 1, 2023.

(51) Int. Cl. H01F 37/00; H01F 27/29; H01F 27/33; H01F 27/34

(52) U.S. Cl. CPC H01F 37/00; H01F 27/292; H01F 27/33; H01F 27/34

(57) ABSTRACT

Exemplary embodiments are disclosed of multichannel EMI inductors. In exemplary embodiments, an inductor comprises a magnetic core and at least eight or more signal lines. The magnetic core includes opposite first and second sides. The magnetic core defines an opening that extends through the magnetic core from the first side to the second side. The at least eight or more signal lines extend through the same single opening of the magnetic core. The at least eight or more signal lines comprise pins partially embedded within a dielectric body such that end portions of the pins are exposed and not embedded within the dielectric body. The end portions of the pins are configured to have a non-linear shape.

### CROSS-REFERENCE TO RELATED APPLICATION

This application is a continuation-in-part (CIP) of PCT International Patent Application PCT/CN2023/097785 filed Jun. 1, 2023 (published as WO 2024/243962 on Dec. 5, 2012), which is incorporated herein by reference in its entirety.

### FIELD

The present disclosure generally relates to multichannel EMI (electromagnetic interference) inductors.

### BACKGROUND

This section provides background information related to the present disclosure which is not necessarily prior art.

Traditional local area network (LAN) magnetic common mode choke (CMC) components encounter challenges with Power-over-Ethernet (POE) applications. For example, power capacity increases may pose a problem because small enamel wire and its winding process may have difficulty in sustaining higher electrical currents associated with POE applications.

The common mode choke is an integral part of the LAN magnetics between the MAC & PHY IC (medium access control (MAC) and physical layer (PHY) integrated circuit) and input/output (I/O) ports. The common mode choke is responsible for suppresion of common mode noises including electrostatic discharge (ESD) protection. According to LAN 802.XX protocol, conventionally there are eight lines reserved in twist wire to transmit-receive data in differential mode signals. By way of example, FIGS. 14, 15, and 16 respectively illustrate three different types of convenional LAN-CMC product platforms 1401, 1501, and 1601.

### DRAWINGS

The drawings described herein are for illustrative purposes only of selected embodiments and not all possible implementations and are not intended to limit the scope of the present disclosure.

FIG. 1 illustrates a first exemplary embodiment of a multichannel EMI inductor that may be configured for use as a high power smaller size filter inductor in a Power-over-Ethernet (POE) application.

FIG. 2 illustrates a second exemplary embodiment of a multichannel EMI inductor that may be configured for use as a high power smaller size filter inductor in a Power-over-Ethernet (POE) application.

FIGS. 3 and 4 illustrate a third exemplary embodiment of a multichannel EMI inductor that may be configured for use as a high power smaller size filter inductor in a Power-over-Ethernet (POE) application.

FIG. 5 includes bottom, end, top, and side views of the inductor shown in FIG. 4 with exemplary dimensions in millimeters according to an exemplary embodiment of the present disclosure. The dimensions provided in FIG. 5 are examples only and provides for purpose of illustration only as the inductor in other exemplary embodiments may be configured differently, e.g., with smaller or larger dimensions, etc.

FIG. 6 illustrates a recommended or preferred land pattern for the inductor shown in FIGS. 3 and 4 with exemplary dimensions in millimeters according to an exemplary embodiment of the present disclosure. The dimensions provided in FIG. 6 are examples only for purpose of illustration as the inductor in other exemplary embodiments may be configured differently, e.g., with smaller or larger dimensions, etc.

FIG. 7 is a table with example electrical specifications that may be used for the inductor shown in FIGS. 3 and 4 according to an exemplary embodiment of the present disclosure.

FIG. 8 illustrates a fourth exemplary embodiment of a multichannel EMI inductor that may be configured for use as a high power smaller size filter inductor in a Power-over-Ethernet (POE) application.

FIG. 9 includes bottom, end, top, and side views of the inductor shown in FIG. 8 with exemplary dimensions in millimeters according to an exemplary embodiment of the present disclosure. The dimensions provided in FIG. 9 are examples only and provides for purpose of illustration only as the inductor in other exemplary embodiments may be configured differently, e.g., with smaller or larger dimensions, etc.

FIG. 10 illustrates a recommended or preferred land pattern for the inductor shown in FIG. 8 with exemplary dimensions in millimeters according to an exemplary embodiment of the present disclosure. The dimensions provided in FIG. 10 are examples only for purpose of illustration as the inductor in other exemplary embodiments may be configured differently, e.g., with smaller or larger dimensions, etc.

FIG. 11 is a table with example electrical specifications that may be used for the inductor shown in FIG. 8 according to an exemplary embodiment of the present disclosure.

FIG. 12 illustrates a circuit equivalent to the inductor shown in FIGS. 3 and 4 and/or the inductor shown in FIG. 8 according to exemplary embodiments of the present disclosure.

FIG. 13 is a line graph showing recommended or preferred soldering conditions for the inductor shown in FIGS. 3 and 4 and/or the inductor shown in FIG. 8 according to exemplary embodiments of the present disclosure.

FIG. 14 illustrates a conventional Ethernet LAN common mode choke, which may be mounted in a line card in a switch or network adapter card at a location close the MAC & PHY IC and external data ports.

FIG. 15 illustrates a conventional Ethernet LAN common mode choke, which may include integrated partial or whole LAN magnetic components in the common mode choke.

FIG. 16 illustrates a conventional Ethernet LAN common mode choke, which may have better manufacturing efficiency and lower cost as compared to the conventional Ethernet LAN common mode chokes shown in FIGS. 14 and 15.

FIG. 17 illustrates a conventional LAN common mode choke including multiple insulated cores in parallel.

Corresponding reference numerals may indicate corresponding (though not necessarily identical) parts throughout the several views of the drawings.

### DETAILED DESCRIPTION

Example embodiments will now be described more fully with reference to the accompanying drawings.

With POC, POE, POE+, POH in cable and twisted wire applied in external sensors of auto, explore, robot, and AI industrial branches, it is the trend to have no independent power supplier to these sensors. And the POE equipment (such as a sensor) power capacity has increased from 13 Watts (W) (protocol 802.3AF, type1) to 90 W (protocol 802.3BT, type3) in the past years. Although the supplying voltage has remained stable at 12-72 Vdc (normal 48 Vdc), the current needed has increased from 0.35 Adc (protocol 802.3AF, type1) up to 2.5 Adc (protocol 802.3BT, type3). And it seems that this trend of increasing current will continue for a long period of time.

Original EMI magnetics designs did not have a POE function. The coil wires only functioned in a LAN signal transmission role. If a small gauge wire (e.g., AWG36-40, 0.08-0.2 mm diameter) is sufficient for the micro-amp level differential mode signal current and voltage (up to 2.5 Vrms), there would not be additional thermal dissipation problems. And small gauge enamel wire advantageously allows for the formation of compact and well-regulated coils to assemble into a good magnetic path geometry and its core shape (e.g., toroid, other shape, etc.).

But as recognized herein for POE applications, the wire is not only used to transmit-receive data in differential mode signals but also the wire is responsible for the power transport. For popular mode, there are two wires of the eight total wires as the POE positive wire (S wire) and another two wires of the eighth total wires as the POE negative wire (N wire). For this arrangement, each wire will sustain more than 1.0 Amp (A) current. In recent years due to the higher electrical current requests, four wires of the eight total wires act as the POE positive wire (S wire) and the remaining other four wires act as the POE negative wire (N wire). In this example, 0.5 A current may be assigned per each wire. The rated voltage between the S wire groups and the N wire groups may be up to 72 Vdc and is therefore not limited to a signal voltage up to 2.5 Vrms. And necessary insulation and safety design is required if the voltage is beyond 36V safety level according to IEC, UL, and TUV standards.

Under these circumstances, LAN magnetic common mode chokes must address the following challenges or problems:
thicker wires must be used to support higher electricl current (e.g., from micro-amp to several amps)
enough insulation and safety distance between POE S wire and N wire;
thermal problems must be considered;
cost and automated manufacturing are challenges for traditional LAN magnetic components;
with a smaller MOSFET oxygen layer in the IC package, ESD protection is more important. As special common mode noise, ESD is distributed over the whole channels. And how to better suppress the ESD impulse is an important consideration.

After recognizing the above, exemplary embodiments of multichannel EMI inductors were developed and/or are disclosed herein that may be configured to address and/or solve the following problems associated with conventional Ethernet LAN common mode noise chokes/inductors, including:
the inability of conventional Ethernet LAN common mode noise chokes/inductors to sustain higher Power-over-Ethernet (POE) electrical current because of their small enamel wires and the enamel wire winding process limit;
the low safety and insulation grade of conventional traditional Ethernet LAN common mode noise chokes/inductors;
thermal problems associated with conventional traditional Ethernet LAN common mode noise chokes/inductors;
automated manufacturing process challenges associated with conventional traditional Ethernet LAN common mode noise chokes/inductors; and
electrostatic discharge (ESD) issues associated with conventional traditional Ethernet LAN common mode noise chokes/inductors.

Exemplary embodiments disclosed herein may provide or include one or more (but not necessarily any or all) of the following advantageous effects or features including:
stamped metal (e.g., phosphor bronze with tin plating, etc.) pins instead of enamel wire to adapt to high electrical current request and to balance the electrical conductivity and the mechanical strength;
multiple channels/lines in a single construction to meet high power smaller size filter inductor in PoE+application;
good thermal dissipation because of flat construction;
enable 100% automated manufacturing process;
at least eight or more channels/lines in one core hole/in one magnetic loop to maintain best ESD noise suppression;
use of plastic injecting process to guarantee pin pitch and no distortion; and
“L”, “Gull”, or “Winged” shape is applied and embedded within an injection molded body (e.g., liquid crystalline polymer (LCP) grade reinforced with 40% glass fiber, plastic, etc.) for precise SMT (surface mount technology) land pattern and good coplanarity even with many pins.

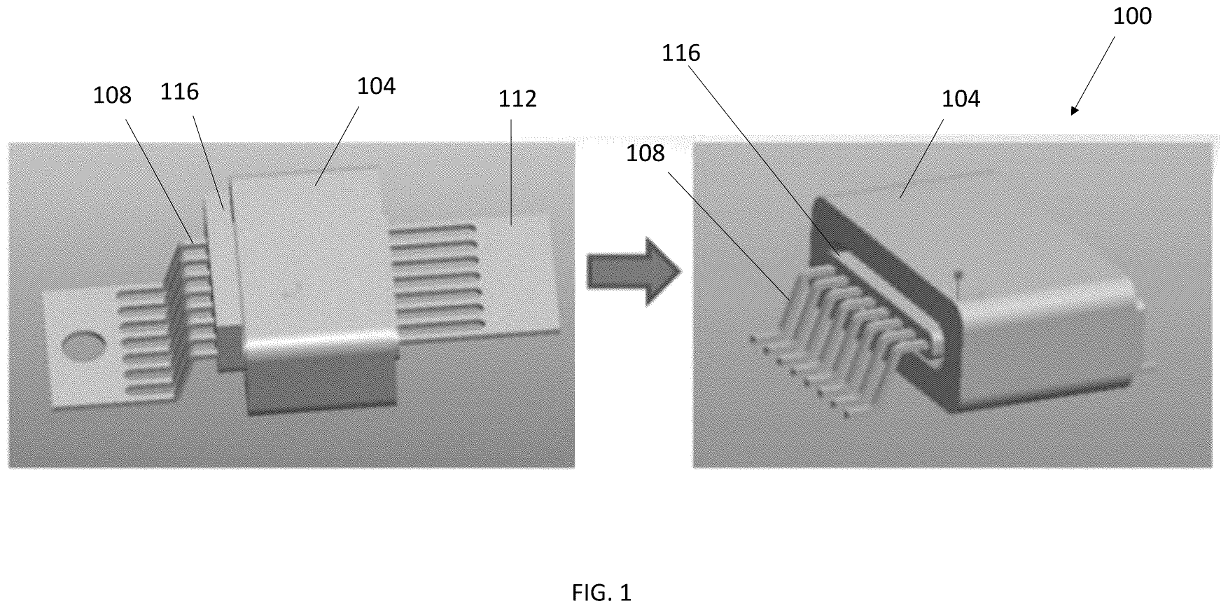

With reference now to the figures, FIG. 1 illustrates a first exemplary embodiment of a multichannel EMI inductor 100 that may be configured for use as a high power smaller size filter inductor in a Power-over-Ethernet (POE) application. In this exemplary embodiment, the inductor 100 comprises a magnetic core 104 configured as a monolithic, single component structure having a perfect magnetic loop and property.

The inductor 100 includes at least eight or more electrically conductive (e.g., metal, etc.) pins 108. The pins 108 are preferably formed from phosphor bronze with tin plating to balance the electrical conductivity and the mechanical strength. The pins 108 may have a rectangular cross-sectional profile. The pins 108 are punched and electroplated from a frame 112.

The pins 108 are bent into “L” pin shape along only one side, which is the left side in FIG. 1. The frame 112 including the pins 108 and a dielectric header 116 (e.g., liquid crystalline polymer (LCP) grade reinforced with 40% glass fiber, plastic, etc.) is slidably inserted into the magnetic core 104 (e.g., ferrite core, etc.). Injection molding guarantees the pin safe pitch and no distortion. The pins 108 are then bent into an “L” pin shape along the other/opposite side, which is the right side in FIG. 1. Each pin 108 thus includes opposite L-shaped end portions between a linear or straight middle portion that cooperatively define “gull” or “winged” shape with fixture, which ultimately obtains the SMD (surface mount device) land pattern. The end portions of frame 112 is trimmed, cut, or otherwise removed such that the only the pins 108 remain.

Accordingly, this exemplary embodiment of the inductor 100 includes at least eight or more signal lines in one core hole, uses a material injecting process to guarantee the pin pitch and no distortion, the pins are “L”, “gull”, or “winged” shape and embedded in a dielectric body (e.g., liquid crystalline polymer (LCP) grade reinforced with 40% glass fiber, plastic, etc.) to obtain a precise SMT land pattern and good coplanarity even with many pins. In this exemplary embodiment, the inductor 100 includes metal pins made from phosphor bronze to balance the electrical conductivity and the mechanical strength. And the inductor 100 includes at least eight or more lines/channels in a single component structure that is usable as a high power smaller size filter inductor in PoE+applications.

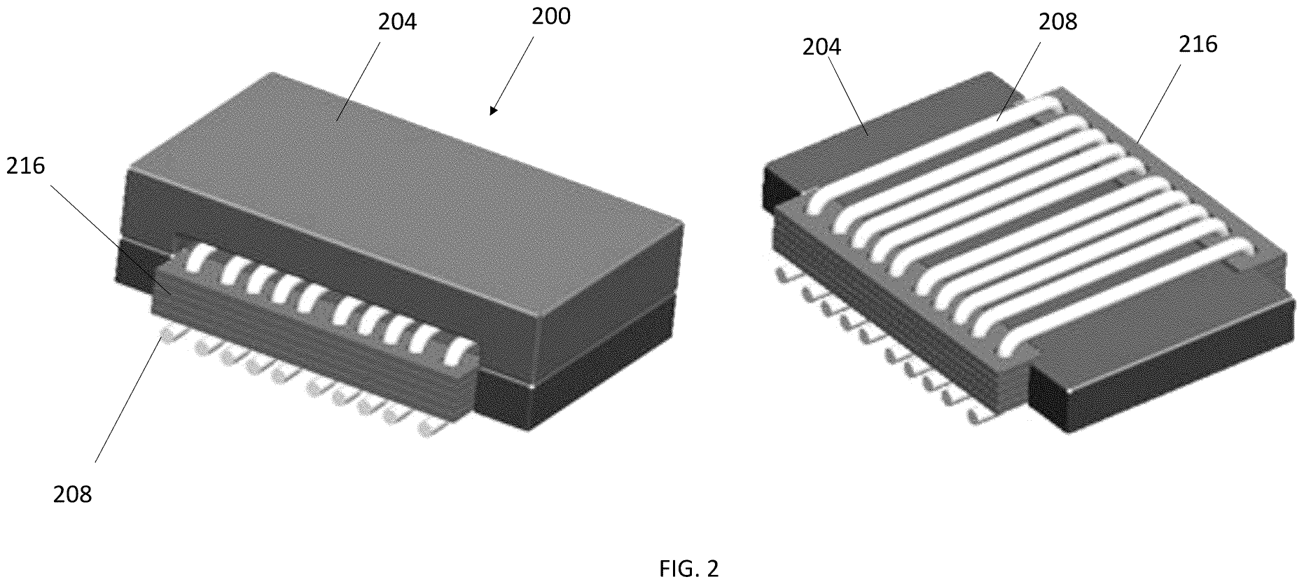

FIG. 2 illustrates a second exemplary embodiment of a multichannel EMI inductor 200 that may be configured for use as a high power smaller size filter inductor in a Power-over-Ethernet (POE) application. Advantageously, this exemplary embodiment of the inductor 200 may provide a cost competitive and flexible solution to respond to customized requests in short time without requiring any additional tooling and materials investment to support the prototypes and small sample order.

The inductor 200 comprises a magnetic core 204 (e.g., a ferrite core, etc.) comprising first and second core portions or halves (e.g., U-shaped core, I-shaped core, U-shaped core halves, etc.) are assembled to obtain enough impedance per request. The inductor 200 includes at least ten or more enamel wires 208 having a round cross-sectional profile. The wires 208 are directly inserted into orientation holes of a dielectric header 216 (e.g., liquid crystalline polymer (LCP) grade reinforced with 40% glass fiber, plastic, etc.) along both sides to thereby guarantee the pin pitches. The pin terminals or end portions of the wires 208 are bent into an “L” shape as SMT (surface mount technology) pads.

Accordingly, this exemplary embodiment of the inductor 200 includes at least eight or more signal lines in one core hole, uses a material injecting process to guarantee the pin pitch and no distortion, the pins are “L”, “gull”, or “winged” shape and embedded in a dielectric body (e.g., liquid crystalline polymer (LCP) grade reinforced with 40% glass fiber, plastic, etc.) to obtain a precise SMT land pattern and good coplanarity even with many pins. In this exemplary embodiment, the inductor 200 includes at least eight or more lines/channels in a single component structure that is usable as a high power smaller size filter inductor in PoE+applications.

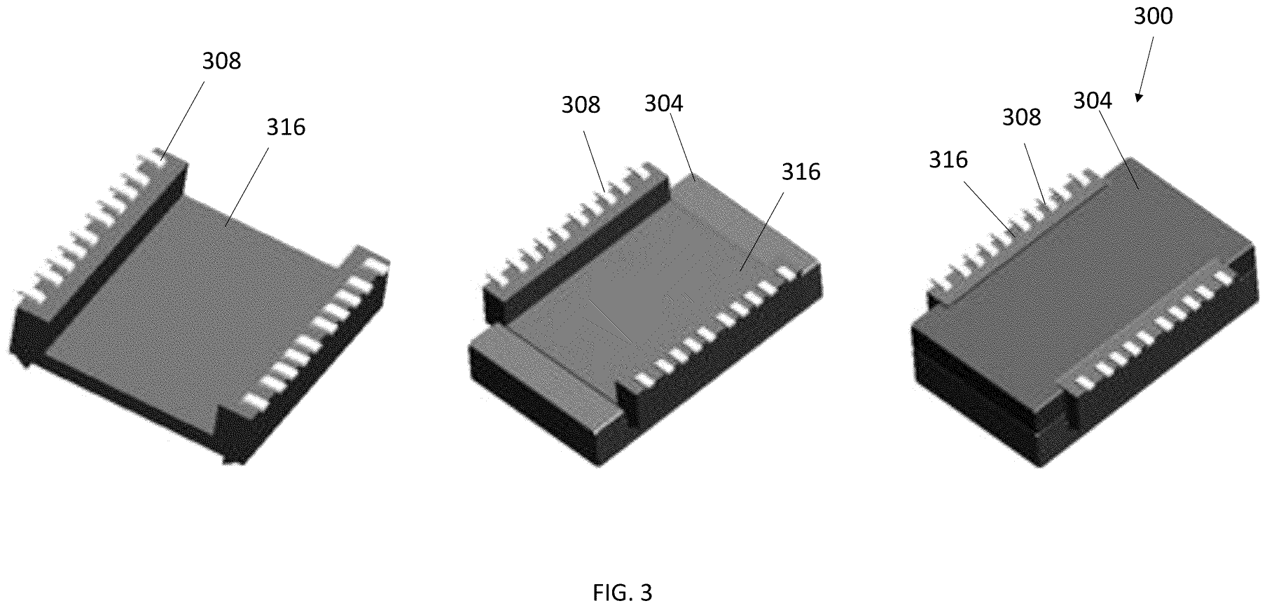

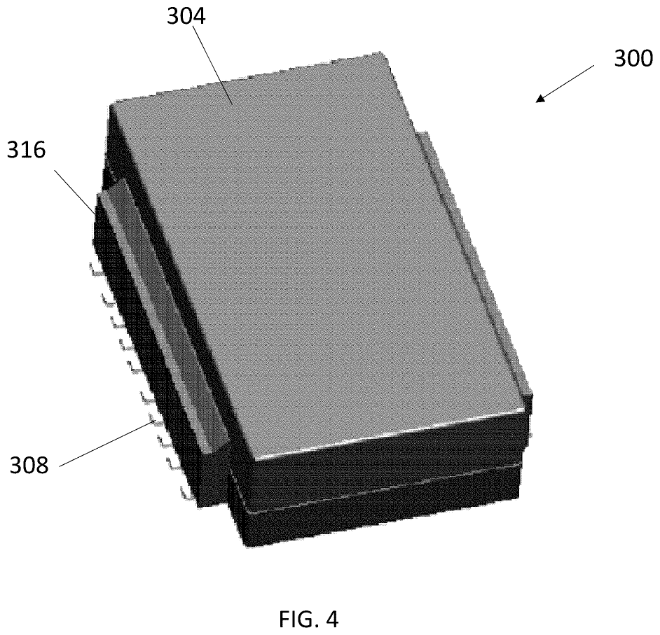

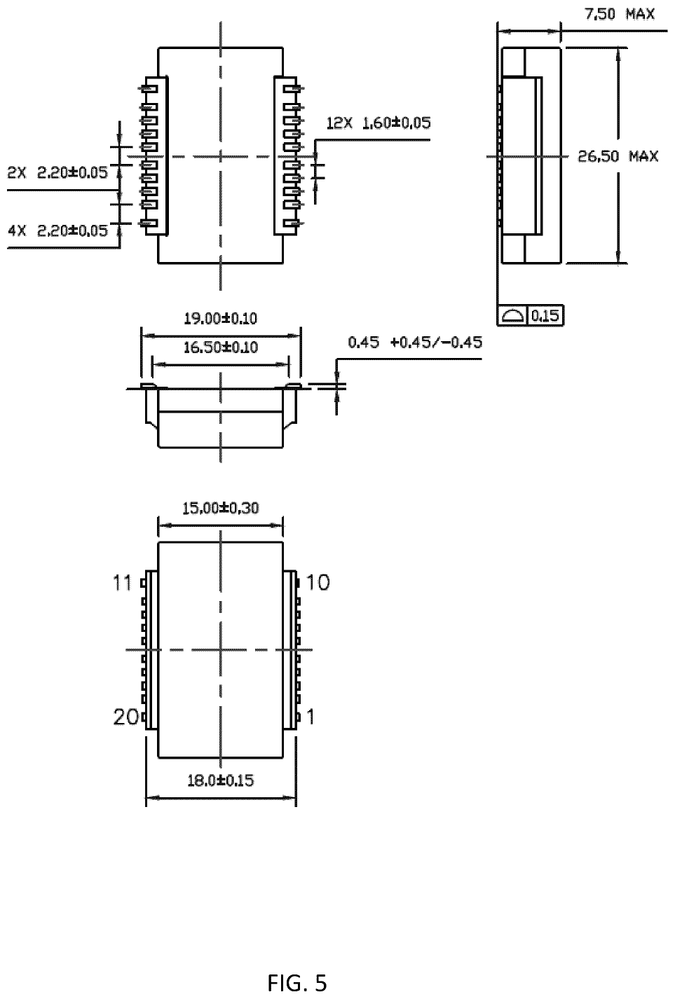

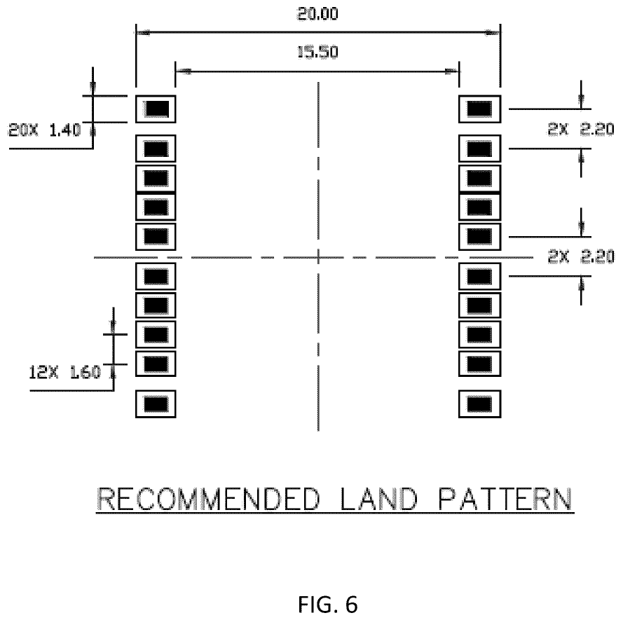

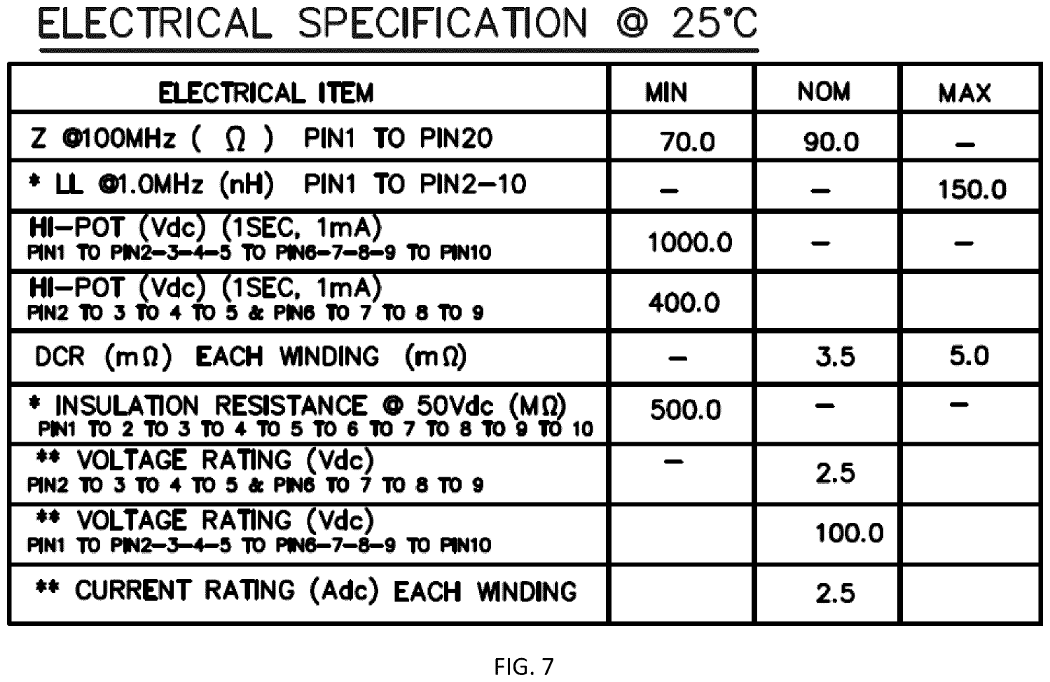

FIG. 3 illustrates a third exemplary embodiment of a multichannel EMI inductor 300 that may be configured for use as a high power smaller size filter inductor in a Power-over-Ethernet (POE) application. Advantageously, this exemplary embodiment of the inductor 300 may combine the construction advantages of the inductors 100, 200 to obtain the best SMD platform solution for automotive manufacture request. More precise land pattern and smaller package size and higher mounted density are advantages realizable by the inductor 300.

In this exemplary embodiment, the inductor 300 comprises a magnetic core 304 (e.g., a ferrite core, etc.) and at least ten or more electrically conductive (e.g., metal, etc.) pins 308. The pins 308 are preferably formed from phosphor bronze with tin plating. The pins 308 may have a rectangular cross-sectional profile.

The pins 308 are directly inserted into orientation holes of a dielectric header 316 (e.g., liquid crystalline polymer (LCP) grade reinforced with 40% glass fiber, plastic, etc.) to thereby guarantee the pin pitches. The terminals or end portions of the pins 308 are bent into an “L” shape as SMT (surface mount technology) pads.

Accordingly, this exemplary embodiment of the inductor 300 includes at least eight or more signal lines in one core hole, uses a material injecting process to guarantee the pin pitch and no distortion, the pins are “L”, “gull”, or “winged” shape and embedded in a dielectric body (e.g., liquid crystalline polymer (LCP) grade reinforced with 40% glass fiber, plastic, etc.) to obtain a precise SMT land pattern and good coplanarity even with many pins. In this exemplary embodiment, the inductor 300 includes metal pins made from phosphor bronze to balance the electrical conductivity and the mechanical strength. And the inductor 300 includes at least eight or more lines/channels in a single component structure that is usable as a high power smaller size filter inductor in PoE+applications.

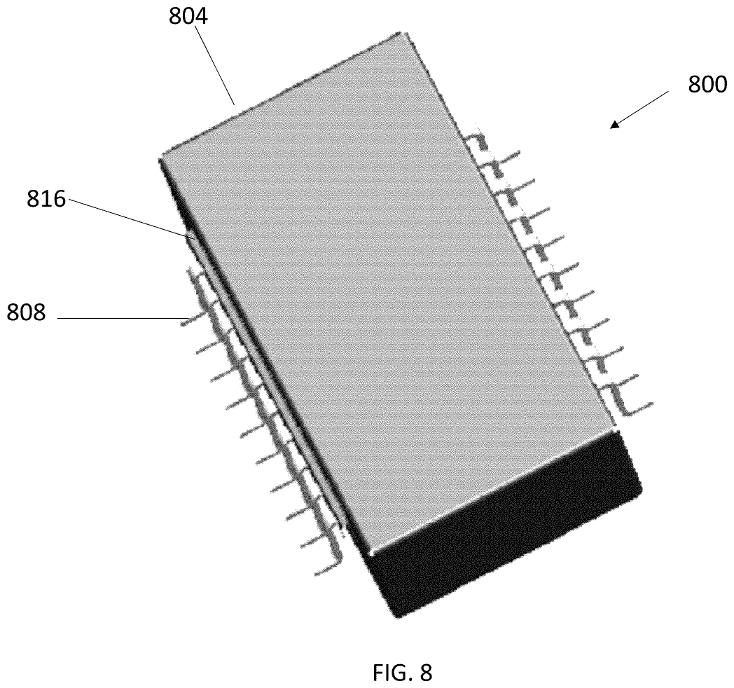

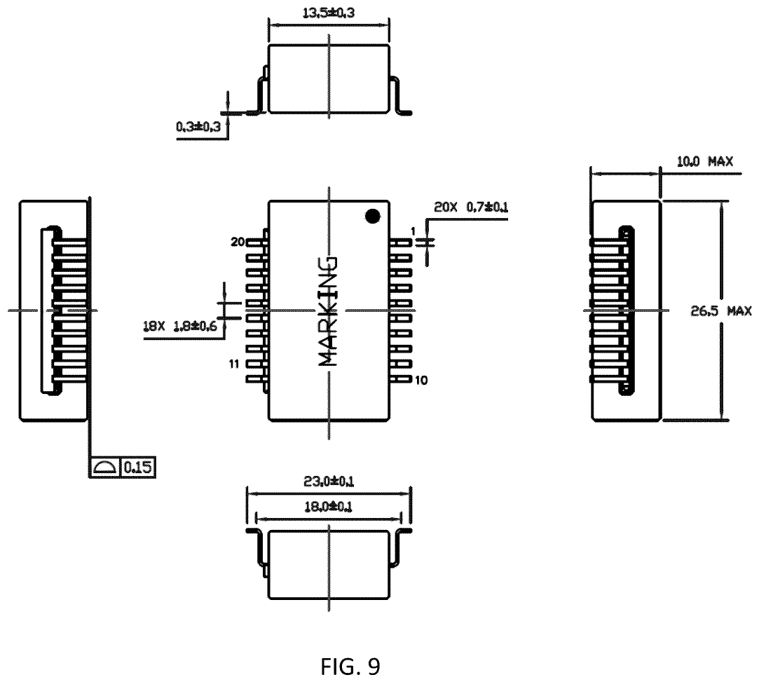

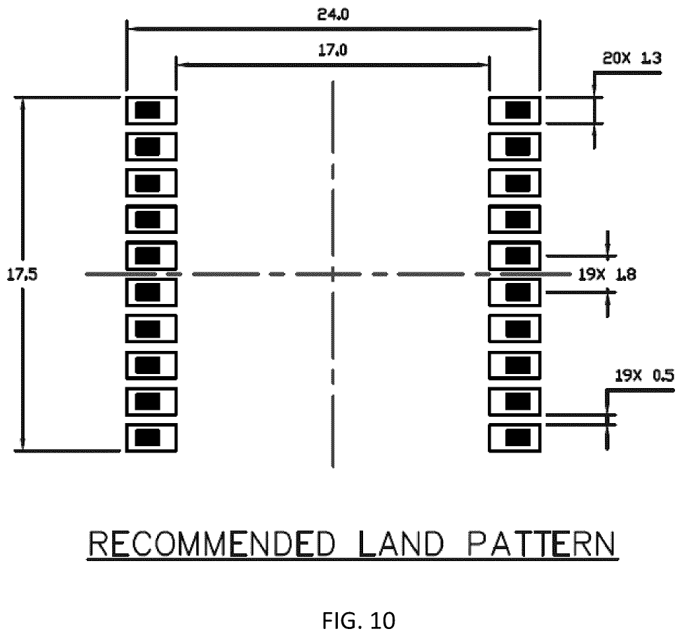

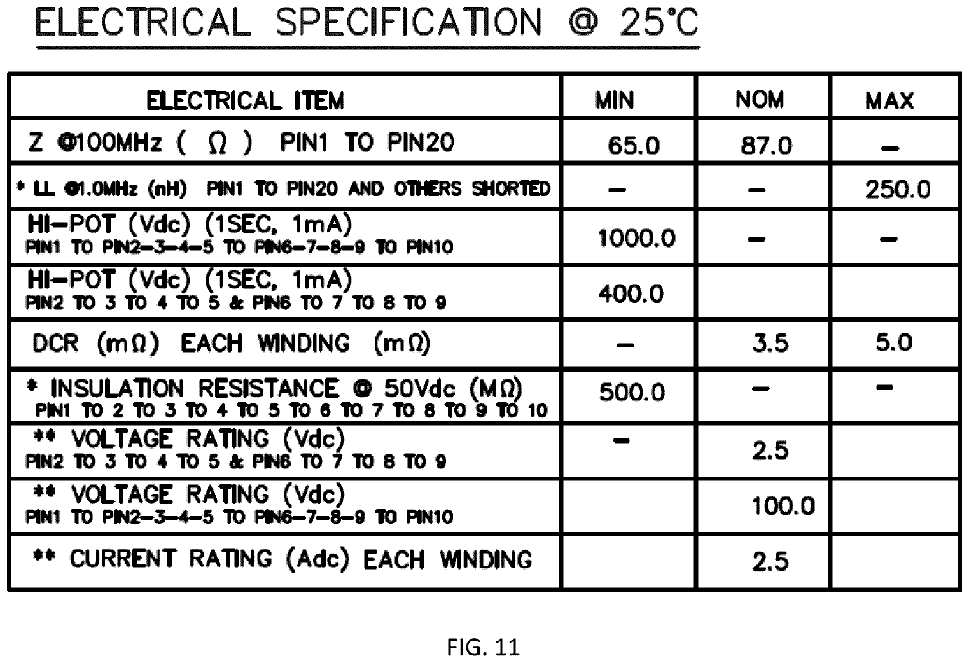

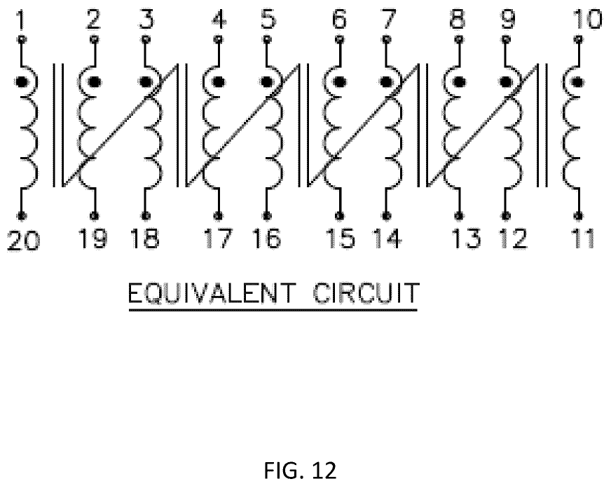

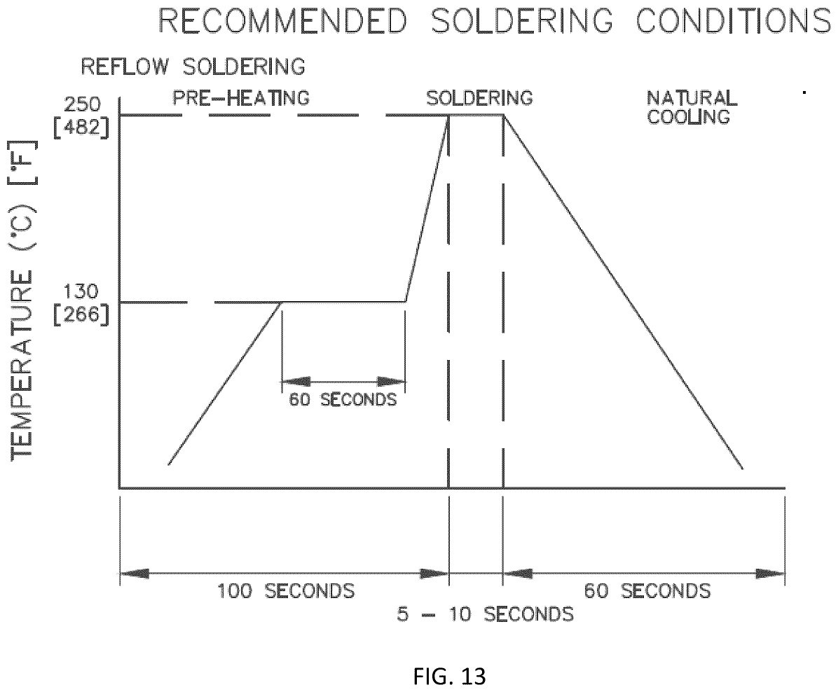

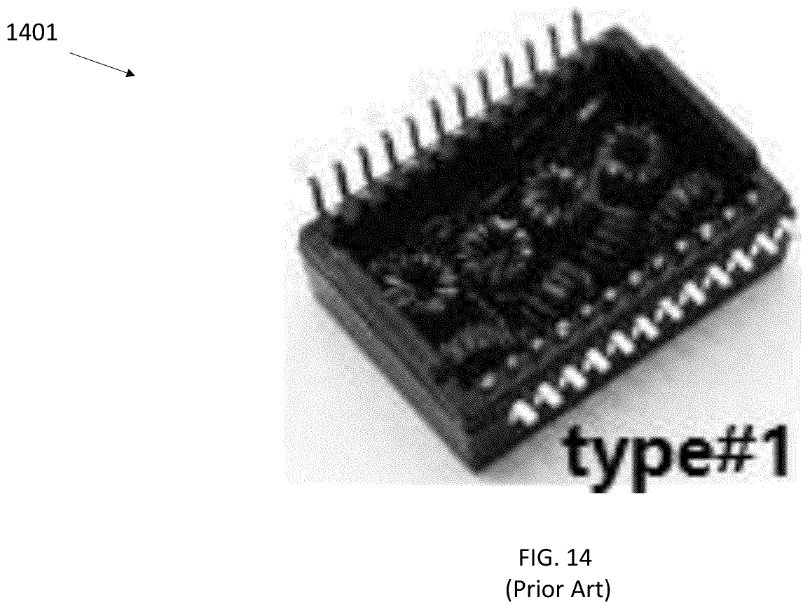

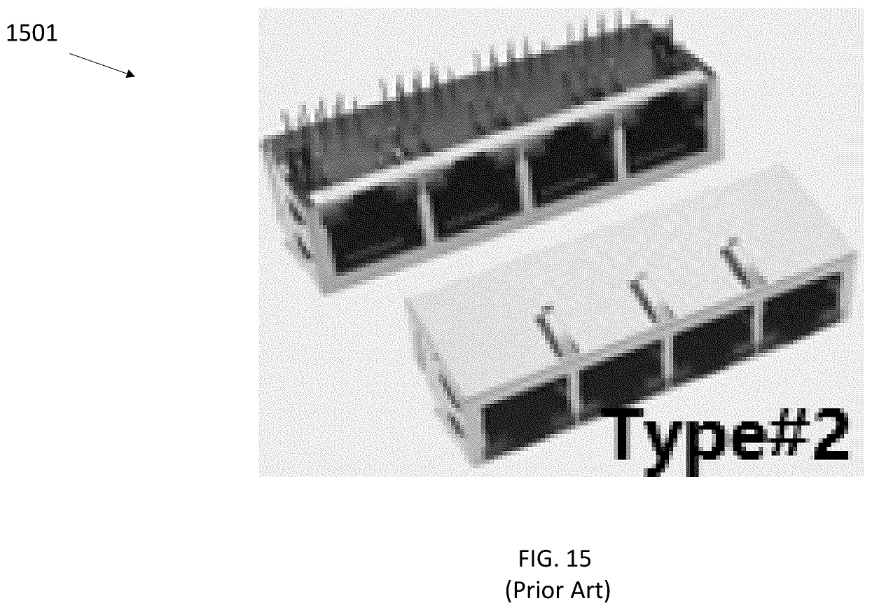

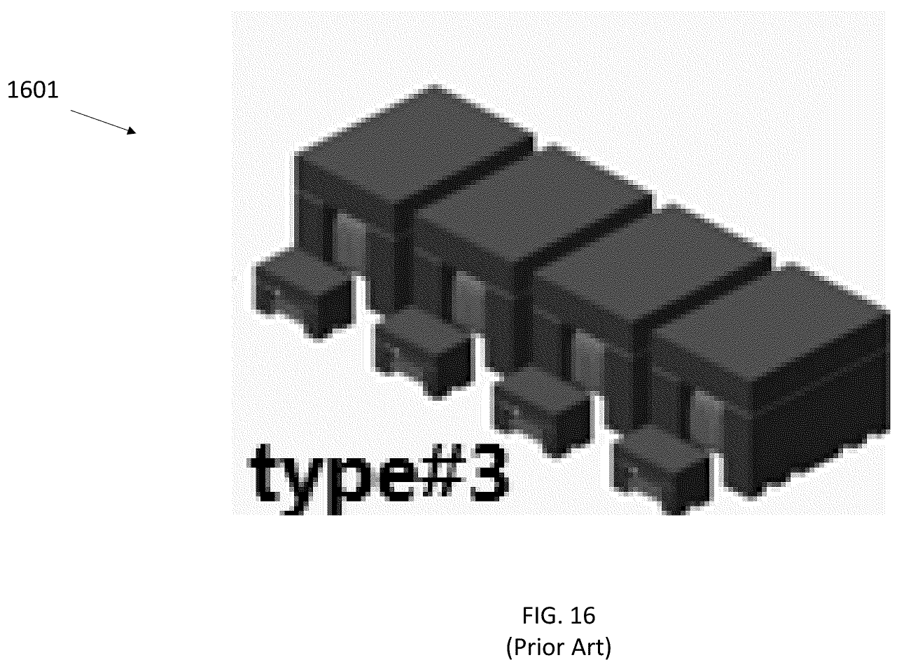

FIG. 8 illustrates a fourth exemplary embodiment of a multichannel EMI inductor 800 that may be configured for use as a high power smaller size filter inductor in a Power-over-Ethernet (POE) application. In this exemplary embodiment, the inductor 800 comprises a magnetic core 804 (e.g., a ferrite core, etc.) and at least ten or more electrically conductive (e.g., metal, etc.) pins 808. The magnetic core 804 has a monolithic, single component structure.

The pins 808 are preferably formed from phosphor bronze with tin plating. The pins 808 may have a rectangular cross-sectional profile. The pins 808 are directly inserted into orientation holes of a dielectric header 816 (e.g., liquid crystalline polymer (LCP) grade reinforced with 40% glass fiber, plastic, etc.) to thereby guarantee the pin pitches. The terminals or end portions of the pins 808 are bent into an “L” shape as SMT (surface mount technology) pads.

In this exemplary embodiment, the end portions of the pins 808 are bent into an “L” shape to thereby define an SMT (surface mount technology) land pattern and such that each pin 808 includes opposite L-shaped end portions between a linear or straight middle portion that cooperatively define an overall gull or winged shape. The linear or straight middle portion of each pin 808 extends through the same single opening of the magnetic core 804. And the pins 808 are partially embedded with the dielectric body 816 to maintain pin pitch without distortion, to provide a precise SMT land pattern, and/or to maintain good coplanarity.

Exemplary embodiments of the inductors disclosed herein (e.g., inductor 100 (FIG. 1), inductor 200 (FIG. 2), inductor 300 (FIG. 3), inductor 800 (FIG. 8), etc.) are configured to provide good ESD protection, unexpected impulse insulation, common mode noise suppression and “crosstalk” between respectively transmitted and received signal channels. When faced with the above recognized challenges in higher and higher power capacity POE applications, the exemplary embodiments of the inductors disclosed herein are excellent in terms of flexibility and competition.

Conventional LAN common mode chokes that include enamel wire to wind the toroid or other shaped cores have limits on the wire cross-sectional shape and gauge (thick or thin) because of the winding machine types. The exemplary embodiments of the inductors disclosed herein (e.g., inductor 100 (FIG. 1), inductor 200 (FIG. 2), inductor 300 (FIG. 3), inductor 800 (FIG. 8), etc.) do not have such limitations regarding wire choice as wires having round or rectangular cross-sectional shapes are acceptable. The exemplary embodiments of the inductors disclosed herein also allow for a wide wire gauge choice, e.g., from 0.1 millimeters (mm) to 2.0 mm wire diameters are acceptable. And corresponding rated current can be up to tens of Amps of current. A designer can freely select the most appropriate wire characteristics per the actual application condition.

For conventional LAN common mode chokes, the insulation and corresponding rated voltage is based on the coating layer of the enamel wire. The safety grade is a function of the insulation per IEC, UL and 3C, etc. For the exemplary embodiments of the inductors disclosed herein (e.g., inductor 100 (FIG. 1), inductor 200 (FIG. 2), inductor 300 (FIG. 3), inductor 800 (FIG. 8), etc.), the insulation between the pins (e.g., phosphor bronze pins, wires, etc.) is guaranteed by enough air distance and the dielectric body itself, such that the insulation grade can be up to basic insulation and even reinforced insulation. The insulation will be enough for possible communication voltage applications now and in the future.

In a conventional common mode choke coil construction, the thermal resistance from the hot point to surface is from 1 Celsius per watt (° C./W) to 20° C./W. By comparison, the exemplary embodiments of the inductors disclosed herein (e.g., inductor 100 (FIG. 1), inductor 200 (FIG. 2), inductor 300 (FIG. 3), inductor 800 (FIG. 8), etc.) are configured such that there is almost 100% contact with the plastic and the core and air. The corresponding thermal resistance is less than 0.5° C./W, and the heat is distributed well with essentially or almost no hot point problem.

Although conventional LAN common mode chokes gradually support automated manufacture after continuous improvement, its efficiency is still low especially for the assembly procedure. The exemplary embodiments of the inductors disclosed herein (e.g., inductor 100 (FIG. 1), inductor 200 (FIG. 2), inductor 300 (FIG. 3), inductor 800 (FIG. 8), etc.) are suitable for a 100% automated manufacture of the whole process. And the automated manufacturing equipment is relatively standard and not overly complex.

The exemplary embodiments of the inductors disclosed herein (e.g., inductor 100 (FIG. 1), inductor 200 (FIG. 2), inductor 300 (FIG. 3), inductor 800 (FIG. 8), etc.) are conducive to maintenance and corresponding cost is competitive.

A smaller MOSFET oxygen layer in the integrated circuit (IC) package increase the importance of ESD protection. For special common mode noise, ESD is distributed over the whole channels. And how to better suppress the ESD impulse is an important consideration.

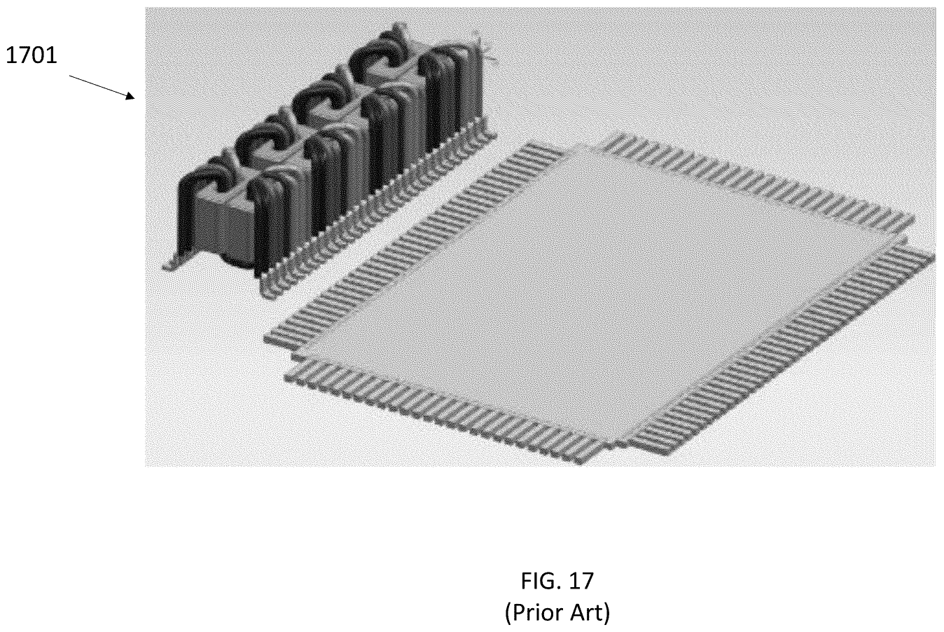

For example, FIG. 17 shows a conventional LAN common mode choke 1701, which may include a toroid shaped core or other shaped core. The choke 1701 includes multiple insulated cores in parallel. In this conventional choke, the suppression of the common mode noise especially ESD will be unbalanced resulting in additional differential mode signal noise. And with the POE electrical current increases, the positive and negative line cannot be guaranteed to cancel each other in any isolated core, such that there is a magnetic saturation risk for the magnetic core.

Conventionally, the POE current passes through multiple lines in total, which is worse for isolated lines of a common mode choke in parallel. And these lines respectively pass into different core holes.

In the exemplary embodiments of the inductors disclosed herein (e.g., inductor 100 (FIG. 1), inductor 200 (FIG. 2), inductor 300 (FIG. 3), inductor 800 (FIG. 8), etc.), all signal lines are located in the same or single “one core hole” regardless of how many signals lines are present. Thus, all common mode noise can be suppressed by a single magnetic loop, and the differential mode signal (including the POE power current loop) can be completely cancelled by each other in one magnetic loop, such that there is no magnetic saturation risk.

Accordingly, exemplary embodiments are disclosed of multichannel EMI inductors. In exemplary embodiments, an inductor comprises a magnetic core and at least eight or more signal lines. The magnetic core includes opposite first and second sides. The magnetic core defines an opening that extends through the magnetic core from the first side to the second side. The at least eight or more signal lines extend through the same single opening of the magnetic core. The at least eight or more signal lines comprise pins partially embedded within a dielectric body such that end portions or terminals of the pins are exposed and not embedded within the dielectric body. The end portions of the pins are configured to have a non-linear shape.

In exemplary embodiments, all of the at least eight or more signal lines extend through the same single opening of the magnetic core such that the inductor is operable for suppressing all common mode noise by a single magnetic loop and such that the differential mode signals cancel each other in the single magnetic loop thereby avoiding magnetic saturation risk of the magnetic core.

In exemplary embodiments, the end portions of the pins are bent into an “L” shape to thereby define an SMT (surface mount technology) land pattern. Each pin includes a middle portion extending between the L-shaped end portions. The middle portion of each pin extend through the same single opening of the magnetic core. The pins are partially embedded with the dielectric body to maintain pin pitch without distortion, to provide a precise SMT land pattern, and/or to maintain good coplanarity.

In exemplary embodiments, the end portions of the pins are bent into an “L” shape such that the pins have an overall gull or winged shape.

In exemplary embodiments, the dielectric body comprises injection molded plastic configured to guarantee pin pitch without distortion.

In exemplary embodiments, the pins are made of phosphor bronze to balance the electrical conductivity and the mechanical strength.

In exemplary embodiments, the pins comprise phosphor bronze wires having rectangular cross-sectional profiles.

In exemplary embodiments, the dielectric body comprises a dielectric header defining orientation holes along both the first and second sides of the magnetic core. And the pins are inserted into the orientation holes of the dielectric header. The pins may thus be embedded within the dielectric material of the dielectric header, e.g., which may help guarantee pin pitch and no distortion for precise SMT (surface mount technology) land pattern and good coplanarity even with many pins, etc.

The pins may comprise enamel wires having round cross-sectional profiles that are inserted into the orientation holes of the dielectric header such that end portions of the enamel wires protrude outwardly beyond the dielectric header along opposite sides of the magnetic core. The pins may thus be embedded within the dielectric material of the dielectric header, e.g., which may help guarantee pin pitch and no distortion for precise SMT (surface mount technology) land pattern and good coplanarity even with many pins, etc.

The pins may be phosphor bronze tin-plated pins having a rectangular cross-sectional profile that are inserted into the orientation holes of the dielectric header such that L-shaped end portions of the phosphor bronze tin-plated pins protrude outwardly beyond the dielectric header along opposite sides of the magnetic core. The pins may thus be embedded within the dielectric material of the dielectric header, e.g., which may help guarantee pin pitch and no distortion for precise SMT (surface mount technology) land pattern and good coplanarity even with many pins, etc.

In exemplary embodiments, the magnetic core comprises a U-shaped magnetic core, an I-shaped magnetic core, or first and second U-shaped magnetic core halves. In the latter case, the first and second U-shaped magnetic core halves are coupled together to thereby cooperatively define the opening between the first and second U-shaped magnetic core halves.

In exemplary embodiments, the inductor is configured to be usable within a Power-over-Ethernet (POE) system. In such embodiments, the at least eight or more signal lines may comprise four signal lines configured to be operable as a POE positive S wire and four signals lines configured to be operable as a POE negative N wire.

In exemplary embodiments, the inductor is configured to have a thermal resistance less than 0.5 Celsius per watt (° C./W).

In exemplary embodiments, the magnetic core is a monolithic, single component structure. The end portions of the pins are bent into an “L” shape to thereby define an SMT (surface mount technology) land pattern and such that each pin includes opposite L-shaped end portions between a linear or straight middle portion that cooperatively define an overall gull or winged shape. The linear or straight middle portion of each pin extends through the same single opening of the magnetic core. And the pins are partially embedded with the dielectric body to maintain pin pitch without distortion, to provide a precise SMT land pattern, and/or to maintain good coplanarity.

In exemplary embodiments, a Power-over-Ethernet system comprises an inductor as disclosed herein.

In exemplary embodiments, an inductor comprises a magnetic core having opposite first and second sides and defining a single continuous opening extending from the first side to the second side. A dielectric body comprises injection-molded plastic and configured to maintain signal line pin pitch within +0.05 mm and coplanarity within +0.1 mm. At least eight or more signal lines comprising conductive pins. Each pin has a middle portion extending through the single opening of the magnetic core and opposite end portions bent into an L-shape to define a gull-wing surface mount land pattern. The pins are partially embedded within the dielectric body such that the L-shaped end portions are exposed and not embedded. The signal lines are configured to suppress common mode noise across all lines via a single magnetic loop and to cancel differential mode signals within the single magnetic loop, thereby reducing magnetic saturation risk.

In exemplary embodiments, the pins are made of phosphor bronze having rectangular cross-sectional profiles to balance electrical conductivity and mechanical strength. The dielectric body includes keyed orientation holes on both sides of the magnetic core to ensure correct polarity and alignment during automated assembly. The at least eight or more signal lines extend through the same single continuous opening of the magnetic core such that the inductor is operable for suppressing common mode noise by the single magnetic loop that enables multi-line common mode suppression without magnetic saturation. The magnetic core is a monolithic, single component structure. The thermal resistance of the inductor is less than 0.5° C./W under continuous 2 A load per signal line. The inductor is configured for use in a Power-over-Ethernet (POE) system compliant with IEEE 802.3bt, supporting up to 90 W power delivery. And the at least eight signal lines comprise four signal lines operable as a POE positive S wire and four signals lines operable as a POE negative N wire.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific numerical dimensions and values, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (the disclosure of a first value and a second value for a given parameter may be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “includes,” “including,” “has,” “have,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected, or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances. Or for example, the term “about” as used herein when modifying a quantity of an ingredient or reactant of the invention or employed refers to variation in the numerical quantity that can happen through typical measuring and handling procedures used, for example, when making concentrates or solutions in the real world through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section could be termed a second element, component, region, layer, or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” may encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and may be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An inductor comprising:
a magnetic core including opposite first and second sides, the magnetic core defining an opening that extends through the magnetic core from the first side to the second side; and
at least eight or more signal lines extending through the same single opening of the magnetic core;
wherein the at least eight or more signal lines comprise pins partially embedded within a dielectric body such that end portions of the pins are exposed and not embedded within the dielectric body, the end portions of the pins configured to have a non-linear shape.

2. The inductor of claim 1, wherein all of the at least eight or more signal lines extend through the same single opening of the magnetic core, whereby the inductor is operable for suppressing all common mode noise by a single magnetic loop such that differential mode signals cancel each other in the single magnetic loop thereby avoiding magnetic saturation risk of the magnetic core, whereby the single magnetic loop suppresses common mode noise across all signal lines and maintains magnetic core linearity under operating currents.

3. The inductor of claim 1, wherein:
the end portions of the pins are bent into an “L” shape to thereby define an SMT (surface mount technology) land pattern;
each pin includes a middle portion extending between the L-shaped end portions, the middle portion of each pin extending through the same single opening of the magnetic core; and
the pins are partially embedded with the dielectric body to maintain pin pitch without distortion, to provide a precise SMT land pattern, and/or to maintain good coplanarity.

4. The inductor of claim 1, wherein the end portions of the pins are bent into an “L” shape such that the pins have an overall gull or winged shape that provides enhanced mechanical compliance under thermal cycling and vibration and/or enhances solder joint reliability.

5. The inductor of claim 1, wherein the dielectric body comprises injection molded plastic configured to guarantee pin pitch without distortion.

6. The inductor of claim 1, wherein the pins are made of phosphor bronze having rectangular cross-sectional profiles to balance electrical conductivity and mechanical strength.

7. The inductor of claim 1, wherein the dielectric body includes keyed orientation holes on both sides of the magnetic core to ensure correct polarity and alignment during automated assembly.

8. The inductor of claim 1, wherein:
the dielectric body comprises a dielectric header defining orientation holes along both the first and second sides of the magnetic core; and
the pins are inserted into the orientation holes of the dielectric header;
whereby the orientation holes are keyed to prevent reverse insertion and ensure consistent polarity alignment such as during automated pick-and-place operations.

9. The inductor of claim 1, wherein the magnetic core comprises:
a U-shaped magnetic core;
an I-shaped magnetic core; or
first and second U-shaped magnetic core halves coupled together to thereby cooperatively define the opening between the first and second U-shaped magnetic core halves.

10. The inductor of claim 1, wherein the inductor is configured for use in a Power-over-Ethernet (POE) system compliant with IEEE 802.3bt, supporting up to 90 W power delivery.

11. The inductor of claim 10, wherein the at least eight or more signal lines comprise:
four signal lines operable as a POE positive S wire; and
four signals lines operable as a POE negative N wire.

12. The inductor of claim 1, wherein the thermal resistance of the inductor is less than 0.5° C./W under continuous 2 A load per signal line.

13. The inductor of claim 1, wherein the magnetic core is a monolithic, single component structure.

14. The inductor of claim 13, wherein:
the end portions of the pins are bent into an “L” shape to thereby define an SMT (surface mount technology) land pattern and such that each pin includes opposite L-shaped end portions between a linear or straight middle portion that cooperatively define an overall gull or winged shape;
the linear or straight middle portion of each pin extends through the same single opening of the magnetic core; and
the pins are partially embedded with the dielectric body to maintain pin pitch without distortion, to provide a precise SMT land pattern, and/or to maintain good coplanarity.

15. The inductor of claim 1, wherein:
the end portions of the pins comprise opposite L-shaped end portions between a linear or straight middle portion that cooperatively define an overall gull or winged shape and that define an SMT (surface mount technology) land pattern; and
the dielectric body comprises injection molded plastic in which the pins are partially embedded such that the opposite L-shaped end portions of the pins are exposed and not embedded within the injection molded plastic, whereby the pins are partially embedded with the injection molded plastic to maintain pin pitch without distortion, to provide a precise SMT land pattern, and/or to maintain good coplanarity.

16. The inductor of claim 1, wherein the at least eight or more signal lines extend through the same single opening of the magnetic core such that the inductor is operable for suppressing common mode noise by a single magnetic loop that enables multi-line common mode suppression without magnetic saturation.

17. The inductor of claim 1, wherein the non-linear shape of the exposed end portions of the pins improved mechanical stability and SMT alignment.

18. The inductor of claim 1, wherein:
the dielectric body ensures coplanarity and pitch control during high-speed signal transmission; and/or
the dielectric body is configured to maintain signal line pitch within ±0.05 mm tolerance and coplanarity within ±0.1 mm, thereby enabling high-speed differential signal integrity and robust SMT soldering.

19. An inductor comprising:
a magnetic core having opposite first and second sides and defining a single continuous opening extending from the first side to the second side;
a dielectric body comprising injection-molded plastic and configured to maintain signal line pin pitch within ±0.05 mm and coplanarity within ±0.1 mm; and
at least eight or more signal lines comprising conductive pins, each pin having:
a middle portion extending through the single opening of the magnetic core; and
opposite end portions bent into an L-shape to define a gull-wing surface mount land pattern;
wherein the pins are partially embedded within the dielectric body such that the L-shaped end portions of the pins are exposed and not embedded within the dielectric body; and
wherein the signal lines are configured to suppress common mode noise across all lines via a single magnetic loop and to cancel differential mode signals within the single magnetic loop, thereby reducing magnetic saturation risk.

20. The inductor of claim 19, wherein:
the pins are made of phosphor bronze having rectangular cross-sectional profiles to balance electrical conductivity and mechanical strength;
the dielectric body includes keyed orientation holes on both sides of the magnetic core to ensure correct polarity and alignment during automated assembly;
the at least eight or more signal lines extend through the same single continuous opening of the magnetic core such that the inductor is operable for suppressing common mode noise by the single magnetic loop that enables multi-line common mode suppression without magnetic saturation;
the magnetic core is a monolithic, single component structure;
the thermal resistance of the inductor is less than 0.5° C./W under continuous 2 A load per signal line;
the inductor is configured for use in a Power-over-Ethernet (POE) system compliant with IEEE 802.3bt, supporting up to 90 W power delivery; and
the at least eight signal lines comprise four signal lines operable as a POE positive S wire and four signals lines operable as a POE negative N wire.
